(19) United States
(12) Patent Application Publication
(10) Pub. No.: US 2011/0181390 A1
(43) Pub. Date: Jul. 28, 2011

(54) VEHICLE KEY FOR STORING A VEHICLE IDENTIFICATION

(76) Inventors: Ulrich Stahlin, Eschborn (DE); Maik Schäfer, Fridrichahafen-Kluftern (DE); Ulrich Möller, Holzkirchen (DE)

(21) Appl. No.: 12/988,921

(22) PCT Filed: Apr. 30, 2009
(86) PCT No.: PCT/EP2009/055292

§ 371 Date: Mar. 21, 2011

(30) Foreign Application Priority Data
Apr. 30, 2008 (DE) 10 2008 021 724.7
Apr. 11, 2009 (DE) 10 2009 017 730.2

(51) Int. Cl. G06F 7/04

(52) U.S. Cl. 340/5.61

(57) ABSTRACT

A vehicle key for storing a vehicle identifier with a communication unit and a memory unit, wherein the communication unit is designed to receive the vehicle identifier from a transmitter, and wherein the memory unit is designed to store the received vehicle identifier.

### CROSS REFERENCE TO RELATED APPLICATIONS

This application is the U.S. national phase application of PCT International Application No. PCT/EP2009/055292, filed Apr. 30, 2009, which claims priority to German Patent Application No. 10 2008 021 724.7, filed Apr. 30, 2008, and German Patent Application No. 10 2009 017 730.2, filed Apr. 11, 2009, the contents of such applications being incorporated by reference herein.

### FIELD OF THE INVENTION

The invention relates to the storage of information in a vehicle key. In particular, the invention relates to a vehicle key for storing a vehicle identifier. In addition, the invention relates to a transmitter for sending a vehicle identifier, a system having a vehicle key and a transmitter for programming a vehicle key for the purpose of storing a vehicle identifier, a means of transport with the vehicle key for the purpose of storing the means of transport identifier, the use of a vehicle key for storing the means of transport identifier, and a method for storing a vehicle identifier in a vehicle key.

### BACKGROUND OF THE INVENTION

The license plate or vehicle identifier of a vehicle may be a useful piece of information for identifying and hence more quickly finding the vehicle in the event of an automated emergency call (Ecall), for example. In addition, the license plate can be used for machine-readable identification in community applications.

To date, the information about the license plate has been available only in a form which can be read by humans, however.

### SUMMARY OF THE INVENTION

An object of the invention can be regarded as that of transmitting a vehicle identifier to a vehicle in machine-readable form and easily.

The invention specifies a vehicle key, a transmitter, a system having a vehicle key and a transmitter, a means of transport having a vehicle key, the use of a vehicle key and a method for storing a vehicle identifier in a vehicle key in accordance with aspects of the invention.

In line with one exemplary embodiment of the invention, a vehicle key for a vehicle for the purpose of storing a vehicle identifier with a communication unit and a memory unit is provided. The communication unit is designed to receive the vehicle identifier from a transmitter. The memory unit is designed to store the received vehicle identifier.

Such a vehicle key allows explicit association of the vehicle using the vehicle key.

Such a vehicle key also allows the vehicle identifier, for example a license plate, a chassis number or the vehicle type and/or the vehicle identification number, to be used for identifying and hence more quickly finding the vehicle in the event of an automated emergency call. In addition, the vehicle identifier can be used for identification which can be read by humans in community applications, such as Google Communities.

Such a vehicle key allows the vehicle identifier to be transmitted to the vehicle in a form which can be read by humans and easily.

In line with a further exemplary embodiment of the invention, the vehicle identifier can be input in the vehicle by a user using input facilities, such as a user interface with a keypad.

In line with a further exemplary embodiment of the invention, a vehicle key for a vehicle for the purpose of storing a vehicle identifier with a communication unit is specified, wherein the communication unit is designed to transmit the vehicle identifier to a system component of a vehicle.

In line with a further exemplary embodiment of the invention, the communication unit is designed to transmit the vehicle identifier to any reception unit, for example a reception unit for an emergency call.

In line with a further exemplary embodiment of the invention, the communication unit for the vehicle key is designed to receive the vehicle identifier via a short range communication data link which is set up between the communication unit and the transmitter of the vehicle identifier.

In line with a further exemplary embodiment of the invention, the communication unit can receive the vehicle identifier using a data link between the vehicle key and the vehicle which is otherwise used for the purpose of opening and closing the vehicle (Remote-Keyless-Entry=RKE), and can thereby provide the vehicle identifier from the vehicle key for the system components in the vehicle.

In line with a further exemplary embodiment of the invention, a vehicle key is provided, wherein the vehicle key is in the form of a radio key, wherein the radio key is communicated both for the purpose of transmitting and receiving the vehicle identifier and for the purpose of opening and closing the vehicle. For this, the radio key may have a plurality of control buttons (for example an “Open” button, a “Close” button and a “Transmit” button.

In line with a further exemplary embodiment of the invention, a vehicle key having an authentication unit and an encryption unit is provided. The encryption unit is designed to encrypt the vehicle identifier which is to be transmitted. The authentication unit is designed to decrypt the encrypted vehicle identifier received by the communication unit.

In line with a further exemplary embodiment of the invention, the transmission of the vehicle identifier from a transmitter to a communication unit of the vehicle key is cryptographically encrypted. In this context, the encryption and the authentication are performed using AES, TEA (Tiny Encryption Algorithm) or High Tec, which are used for RKE, for example. AES and TEA are Open Source encryption algorithms.

In line with a further exemplary embodiment of the invention, a transmitter for sending a vehicle identifier to a vehicle key of a vehicle for the purpose of storing a vehicle identifier is specified which has a memory unit and a communication unit. In this case, the memory unit is designed to store the vehicle identifier. The communication unit is designed to send the vehicle identifier to the vehicle key.

In line with a further exemplary embodiment of the invention, a system for programming a vehicle key for the purpose of storing a vehicle identifier with a vehicle key in accordance with one of the preceding exemplary embodiments is specified.

In line with a further exemplary embodiment of the invention, a means of transport having a vehicle key in accordance with one of the preceding exemplary embodiments for the purpose of storing the means of transport identifier is specified.

In line with a further exemplary embodiment of the invention, the use of a vehicle key in accordance with one of the preceding exemplary embodiments for the purpose of storing a means of transport identifier is specified.

In line with a further exemplary embodiment of the invention, a method for storing a vehicle identifier in a vehicle key is specified which has the following steps: the vehicle identifier is received by a communication unit of the vehicle key; the received vehicle identifier is stored by a memory unit of the vehicle key.

In line with a further exemplary embodiment of the invention, the method additionally has the further step of the vehicle identifier being transmitted by a communication unit of the vehicle key to a system component of the vehicle.

The individual features of the various exemplary embodiments can naturally also be combined with one another, which means that in some cases it is also possible for advantageous effects to arise which go beyond the sum of the individual effects, even if these are not expressly described.

In particular, it should be noted that the features described here and below for the vehicle key can also be implemented in the transmitter, the system, the means of transport and the method, and vice versa.

These and other aspects of the invention are explained and illustrated by reference to the exemplary embodiments which are described hereafter.

### BRIEF DESCRIPTION OF THE DRAWINGS

FIG. 1 shows a schematic illustration of a system for programming a vehicle key for the purpose of storing a vehicle identifier based on an exemplary embodiment of the invention.

FIG. 2 shows a flowchart for a method for storing a vehicle identifier in a vehicle key based on an exemplary embodiment of the invention.

### DETAILED DESCRIPTION OF EXEMPLARY EMBODIMENTS

Exemplary embodiments of the invention are described below with reference to the appended drawings.

The illustrations in the figures are schematic and not to scale. In the descriptions of the figures which follow, the same reference symbols are used for the same or similar elements.

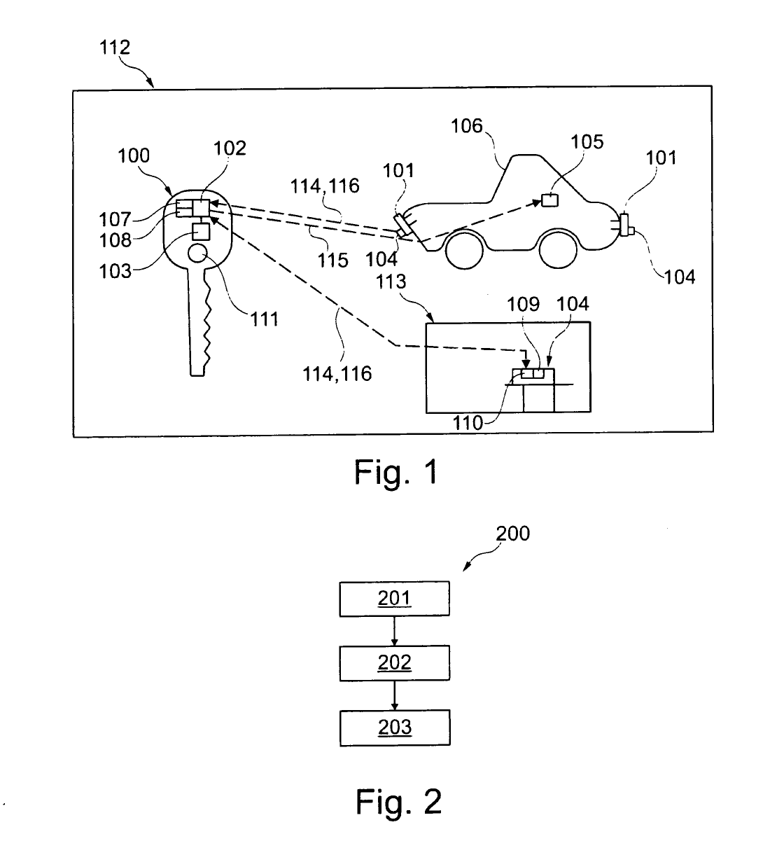

FIG. 1 shows a system 112 for programming a vehicle key 100 for the purpose of storing a vehicle identifier 101 with a vehicle key 100 and a transmitter 104. The vehicle key 100 has a communication unit 102 which is connected to a memory unit 103. The communication unit 102 is designed to receive 114 the vehicle identifier 101 from a transmitter 104. In this case, the transmitter 104 is arranged either on the vehicle identifier 101 or, by way of example, in a garage or a motor vehicle licensing center 113.

At this juncture, it should be noted that the vehicle identifier may be the license number of the vehicle and/or an identification number (such as the chassis number) for the vehicle.

The communication unit 102 is likewise designed to transmit 115 the vehicle identifier 101 to a system component 105 of a vehicle 106. The vehicle identifiers 101 can be fitted to a vehicle 106. An operating unit 111, for example in the form of a button, can switch the communication unit 102 on and off, i.e. can activate and deactivate a send or receive mode of the vehicle key 100.

The vehicle key 100 also has an authentication unit 107 and an encryption unit 108. The encryption unit 108 is designed to encrypt the vehicle identifier 101 which is to be transmitted. The authentication unit 107 is designed to decrypt the encrypted vehicle identifier 101 received by the communication unit 102.

The transmitter 104 may be arranged on a vehicle 106 or a vehicle identifier 101 on a vehicle 106 or a vehicle identifier 101 or a motor vehicle licensing center 113 or a garage or another location and has a memory unit 109 and a communication unit 110. The memory unit 109 is designed to store the vehicle identifier 101. The communication unit 110 is designed to send 116 the vehicle identifier 101 to the vehicle key 100, particularly to the communication unit 102 of the vehicle key 100.

FIG. 2 shows a flowchart for a method 200 for storing a vehicle identifier 101 in a vehicle key.

The method 200 has the following steps: in step 201, the vehicle identifier 101 is received 114 by a communication unit 102 of the vehicle key 100. In step 202, the recognized vehicle identifier 101 is then stored by a memory unit 103 of the vehicle key 100. Finally, in step 203, the vehicle identifier 101 is then transmitted by a communication unit 102 of the vehicle key 100 to a system component 105 of a vehicle 106. In this case, step 203 may also involve the vehicle identifier 101 being transmitted to an external receiver 104 by a communication unit 102 of the vehicle key 100.

Although the invention has been described with reference to exemplary embodiments, it is possible to make various changes and modifications without departing from the scope of protection of the invention. The vehicle key according to aspects of the invention can be used for storing any means of transportation identifiers, such as vehicle identifiers, aircraft identifiers, helicopter identifiers, water or rail vehicle identifiers.

In addition, it should be pointed out that “comprising” or “having” does not exclude other elements or steps, and “a” or “an” does not exclude a large number. In particular, the vehicle key may thus have more than one communication unit, more than one memory unit, more than one authentication unit and more than one encryption unit, for example. Similarly, the transmitter may have more than one memory unit and more than one communication unit, and the system may comprise more than one vehicle key and more than one transmitter.

Furthermore, it should be pointed out that features or steps which have been described with reference to one of the above exemplary embodiments can also be used in combination with other features or steps from other exemplary embodiments described above.

1.-12. (canceled)

13. A vehicle key for a vehicle configured for storing a vehicle identifier, said vehicle key comprising:
a communication unit; and
a memory unit;
wherein the communication unit is configured to receive the vehicle identifier from a transmitter;
wherein the memory unit is configured to store the received vehicle identifier.

14. The vehicle key as claimed in claim 13,
wherein the communication unit is configured to transmit the vehicle identifier to a system component of the vehicle.

15. The vehicle key as claimed in claim 13,
wherein the communication unit is configured to receive the vehicle identifier via a short range communication data link which exists between the communication unit and the transmitter of the vehicle identifier.

16. The vehicle key as claimed in claim 13,
wherein the vehicle key is in the form of a radio key;
wherein the radio key is communicated both for the purpose of transmitting and receiving the vehicle identifier and for the purpose of contactlessly opening and closing the vehicle.

17. The vehicle key as claimed in claim 14, further comprising:
an authentication unit;
an encryption unit;
wherein the encryption unit is configured to encrypt the vehicle identifier which is to be transmitted,
wherein the authentication unit is configured to decrypt the encrypted vehicle identifier received by the communication unit.

18. A means of transport having a vehicle key as claimed in claim 13 for the purpose of storing a means of transport identifier for the vehicle.

19. The use of a vehicle key as claimed in claim 13 for the purpose of storing a means of transport identifier.

20. A transmitter for sending a vehicle identifier to a vehicle key of a vehicle for the purpose of storing a vehicle identifier, said transmitter comprising:
a memory unit;
a communication unit;
wherein the memory unit is configured to store the vehicle identifier;
wherein the communication unit is configured to send the vehicle identifier to the vehicle key.

21. A system for programming a vehicle key for the purpose of storing a vehicle identifier, said system having:
a transmitter as claimed in claim 20; and
a vehicle key for a vehicle configured for storing a vehicle identifier, said vehicle key having a communication unit and a memory unit, wherein the communication unit is configured to receive the vehicle identifier from a transmitter, and the memory unit is configured to store the received vehicle identifier.

22. A method for storing a vehicle identifier in a vehicle key, said method comprising the steps of:
receiving the vehicle identifier by a communication unit of the vehicle key; and
storing the received vehicle identifier by a memory unit of the vehicle key.

23. The method as claimed in claim 22 further comprising the step of transmitting the vehicle identifier by a communication unit of the vehicle key to a system component of the vehicle.

24. The method as claimed in claim 22 further comprising the step of transmitting the vehicle identifier by a communication unit of the vehicle key to an external receiver.
